(19) United States
(12) Patent Application Publication
(10) Pub. No.: US 2026/0161484 A1
(43) Pub. Date: Jun. 11, 2026

(54) METHOD, COMPUTER DEVICE, AND COMPUTER PROGRAM TO PROVIDE AI FUNCTION AS API

(71) Applicant: LINE Plus Corporation, Seongnam-si (KR)

(72) Inventors: Hyo Gun LEE, Seongnam-si (KR); Seungjae BAEK, Seongnam-si (KR)

(73) Assignee: LINE Plus Corporation, Seongnam-si (KR)

(21) Appl. No.: 19/071,098

(22) Filed: Mar. 5, 2025

(30) Foreign Application Priority Data
May 28, 2024 (KR) 10-2024-0069127

(51) Int. Cl. G06F 9/54; G06F 40/40

(52) U.S. Cl. CPC G06F 9/541; G06F 40/40

(57) ABSTRACT

Disclosed are a method, a computer device, and a non-transitory computer-readable recording medium to generate and provide an artificial intelligence (AI) function as an application programming interface (API) that may provide a toolbox for generating an AI function as an API, and may execute the AI function through the toolbox and provide execution results in response to a request from a user.

### CROSS-REFERENCE TO RELATED APPLICATION

This U.S. non-provisional application and claims the benefit of priority under 35 U.S.C. § 119 to Korean Patent Application No. 10-2024-0069127, filed May 28, 2024, the entire contents of which are incorporated herein by reference in their entirety.

### BACKGROUND

### Technical Field

Some example embodiments relate to technology for supporting development of a new artificial intelligence (AI) application programming interface (API).

### Related Art

With the recent development of artificial intelligence (AI) technology, research and development on various AI application technologies are being actively conducted. For example, as tangible results, such as work efficiency and productivity improvement through AI utilization, are beginning to be achieved, expectations are rising for the introduction of AI in various industries.

An AI platform that is a system used when developing an AI model may train a designed AI model using data and validate the trained AI model using data. For this AI platform, various commercial products and opensource projects combined with a cloud environment are being actively researched.

As an example of technology that supports AI development, technology for validating an AI model using a framework for building a trusted environment of the AI model is disclosed in Korean Patent Laid-Open Publication No. 10-2023-0126799 (published on Aug. 31, 2023).

### SUMMARY

Some example embodiments may write an artificial intelligence (AI) function as an application programming interface (API) using a dedicated toolbox tool without a separate code work or server deployment.

Some example embodiments may provide an environment that may be flexibly linked to a large language model (LLM) by writing a function and input/output (I/O) specification for each API when writing an AI API.

According to some example embodiments, there is provided a computer device including at least one processor configured to execute computer-readable instructions, wherein the processor is configured to provide a toolbox for generating an artificial intelligence (AI) function as an application programming interface (API), and execute the AI function through the toolbox and provide execution results in response to a request from a user.

According to some example embodiments, the toolbox may include a step that represents a single execution unit executed in the toolbox, and an action that represents a function unit provided in an API form executable in the toolbox.

According to some example embodiments, the step may be managed in one-to-one correspondence with an actual execution code, and may include an input schema and an output schema, and a variable for execution.

According to some example embodiments, the action may be defined by connecting at least two steps in a directed acyclic graph (DAG) form.

According to some example embodiments, the action may be generated through a combination of steps, and an API specification and a description may be specified in a text form.

According to some example embodiments, the toolbox may include a step builder configured to generate a step instance by connecting a specification of the step to an actual execution code of a corresponding step.

According to some example embodiments, the action may be generated through a combination of steps, and the step builder defined for each step may be executed when the action is generated, and used to verify validity of data to build the step.

According to some example embodiments, the action may be generated through a combination of steps, and the step builder may be configured to verify settings of a value for each step for the steps defined in the action, and verify output of a previous step and input of a subsequent action of the action.

According to some example embodiments, the toolbox may include an action builder configured to generate an executable action from an action specification, and the action builder is configured to verify validity for step specification set to the action for the action that is generated through a combination of steps.

According to some example embodiments, the step builder may be configured to generate step objects for the steps defined in the action, and an action builder is configured to generate an action object with a step directed acyclic graph (DAG) according to the combination of the steps.

According to some example embodiments, the at least one processor is configured to provide an intelligent function by fusing the action provided from the toolbox with a large language model (LLM) as a role of an action selector.

According to some example embodiments, the action may be generated through a combination of steps, and API specification and description are specified in a text form, and the action selector is configured to provide a dynamic function through text by fusing specification for the action defined in text and the LLM.

According to some example embodiments, the action selector is configured to execute an action selected by the LLM in the toolbox in response to a query from the user, and deliver a reply to the query to the user.

According to some example embodiments, the action selector is configured to execute an action selected by the LLM in the toolbox as an action suitable for a query from the user among actions specified in text in the toolbox.

According to some example embodiments, there is provided an AI function providing method of a computer device including at least one processor, the AI function providing method including providing, by the at least one processor, a toolbox for generating an AI function as an API; and executing, by the at least one processor, the AI function through the toolbox and providing execution results in response to a request from a user.

According to some example embodiments, there is provided a non-transitory computer-readable recording medium storing instructions that, when executed a processor, cause the processor to perform the AI function providing method on the computer device.

Further areas of applicability will become apparent from the description provided herein. The description and example embodiments in this summary are intended for purposes of illustration only and are not intended to limit the scope of the present inventive concepts.

### BRIEF DESCRIPTION OF DRAWINGS

FIG. 1 is a diagram illustrating an example of a network environment according to some example embodiments;

FIG. 2 is a diagram illustrating an example of a computer device according to some example embodiments;

FIG. 3 is a flowchart illustrating an example of a method performed by a computer device according to some example embodiments;

FIG. 4 illustrates a step build example according to some example embodiments;

FIG. 5 illustrates an example of an action structure generated by connecting steps according to some example embodiments;

FIG. 6 illustrates an example of an action execution structure according to some example embodiments;

FIG. 7 illustrates an example of a flowchart of an action selector according to some example embodiments;

FIG. 8 illustrates an example of an action build and distribution process according to some example embodiments;

FIG. 9 illustrates an example of an action build and execution process according to some example embodiments; and

FIG. 10 illustrates an example of an action execution in response to a user query according to some example embodiments.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

Some example embodiments relate to technology for supporting development of a new artificial intelligence (AI) application programming interface (API).

Some example embodiments including disclosures set forth herein may provide an environment capable of writing an AI function as an API using a dedicated toolbox tool without a separate code work or server deployment, and flexibly linking to a large language model (LLM) by writing a function and input/output (I/O) specification for each API when writing an AI API.

An AI function providing apparatus according to some example embodiments may be implemented by at least one computer device, and an AI function providing method according to some example embodiments may be performed through at least one computer device included in the AI function providing apparatus. Here, a computer program according to some example embodiments may be installed and run on the computer device, and the computer device may perform the AI function providing method according to some example embodiments under control of the computer program. The aforementioned computer program may be stored in a computer-readable record medium to implement the AI function providing method in conjunction with the computer device.

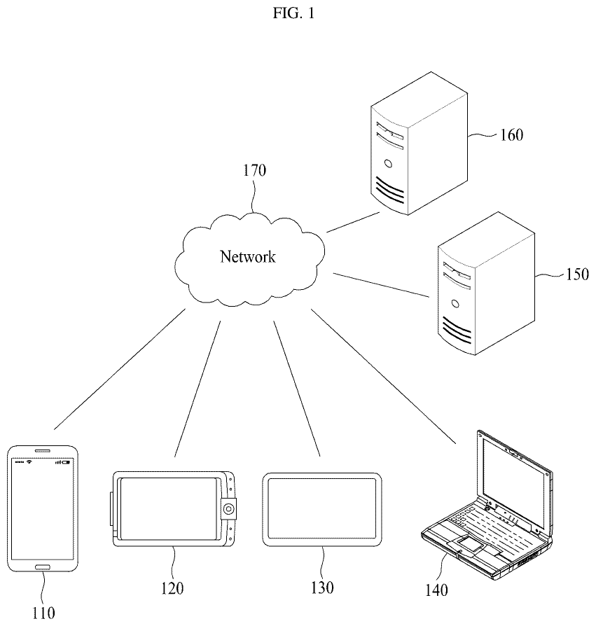

FIG. 1 illustrates an example of a network environment according to some example embodiments. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers are not limited thereto. Also, the network environment of FIG. 1 is provided as one example of environments applicable to some example embodiments and an environment applicable to some example embodiments are not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme according to some example embodiments is not limited, and may include a near field wireless communication scheme between devices as well as a communication scheme using a communication network (e.g., a mobile communication network, wired Internet, wireless Internet, and a broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. In some example embodiments, the network 170 may include at least one of network topologies that include a bus network, a star network, a ring network, a mesh network, a star-bus network, a tree or hierarchical network, and the like. However, example embodiments are not limited thereto.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., AI generation service) to the plurality of electronic devices 110, 120, 130, and 140 connected over the network 170.

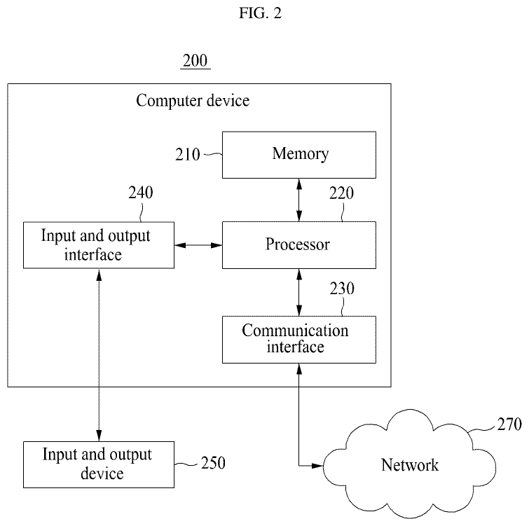

FIG. 2 is a block diagram illustrating an example of a computer device according to some example embodiments. Each of the plurality of electronic devices 110, 120, 130, and 140 or each of the servers 150 and 160 may be implemented by the computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium, but example embodiments are not limited thereto. In some example embodiments, the permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to some example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the computer device 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under control of the communication interface 230. In some example embodiments, a signal, an instruction, data, a file, etc., from another apparatus may be received at the computer device 200 through the communication interface 230 of the computer device 200. A signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc., but example embodiments are not limited thereto. In some example embodiments, the I/O interface 240 may be a device for interfacing with an apparatus in which an input function and an output function are integrated into a single function, such as a touchscreen. The I/O device 250 may be configured as a single apparatus with the computer device 200.

Also, according to some example embodiments, the computer device 200 may include a greater or smaller number of components than the number of components shown in FIG. 2. However, there is no need to clearly illustrate most components. For example, the computer device 200 may be configured to include at least a portion of the I/O device 250 or may further include other components, such as a transceiver and a database, but example embodiments are not limited thereto.

Hereinafter, some example embodiments of methods and apparatuses for generating and providing an AI function as an API is described in detail.

While various AI functions are being developed, a code work and server deployment may be required or may be advantageous to develop a new AI API. Also, for linkage with a large language model (LLM), there may be a need to, or advantage in, separately constructing and managing description and specifications (spec) for each API.

Accordingly, some example embodiments may provide an environment capable of writing an AI function as an API using a dedicated toolbox tool without a separate code work or server deployment, and flexibly linking to a large language model (LLM) by writing a function and I/O specification for each API when writing an AI API.

The computer device 200 according to some example embodiments may provide a client with an AI generation service through connection to a dedicated application installed on the client or website/mobile site related to the computer device 200. In some example embodiments, a computer-implemented AI function providing apparatus may be configured in the computer device 200. For example, the AI function providing apparatus may be implemented in a form of a program that independently operates, or may be configured in an in-app form of a specific or alternatively, desired application to be operable on the specific or alternatively, desired application.

The processor 220 of the computer device 200 may be implemented as a component to perform the following AI function providing method according to some example embodiments. Depending on some example embodiments, the components of the processor 220 may be selectively included in or excluded from the processor 220. Also, depending on some example embodiments, the components of the processor 220 may be separated or merged for functional expression of the processor 220.

The processor 220 and the components of the processor 220 may control, or may be configured to control the computer device 200 to perform operations included in the following AI function providing method according to some example embodiments. For example, the processor 220 and the components of the processor 220 may be implemented to execute an instruction according to a code of at least one program and a code of an OS (operating system) included in the memory 210.

According to some example embodiments, the components of the processor 220 may be expressions of different functions performed by the processor 220 in response to an instruction provided from a program code stored in the computer device 200.

The processor 220 may read a necessary or alternatively desired instruction from the memory 210 to which instructions related to control of the computer device 200 are loaded. For example, the read instruction may include an instruction for controlling the processor 220 to perform operations described below according to some example embodiments.

The operations included in the AI function providing method described below may be performed in order different from the illustration, and some of operations may be omitted or an additional process may be further included.

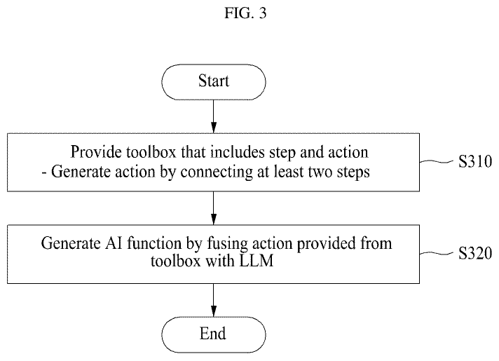

FIG. 3 is a flowchart illustrating an example of an AI function providing method performed by a computer device according to some example embodiments.

Referring to FIG. 3, in operation S310, the processor 220 may provide a toolbox for AI function generation, and may provide the toolbox that includes a step and an action. In some example embodiments, the step may refer to a single execution unit that is executed in the toolbox, and the action may refer to a function unit that is provided in an API form that is executable in the toolbox. In some example embodiments, the processor 220 may generate an action corresponding to a function unit of the toolbox by combining at least two steps provided from the toolbox. The step may not be executed alone, and may need to be generated as an executable function unit called the action through combination to become executable. The processor 220 may provide the toolbox for developing a new AI function by fusing various AI models, and may develop a new function through a combination of steps provided from the toolbox without a need to develop or distribute an additional project in providing a new function. For example, the processor 220 may develop the new function through a combination of steps provided from the toolbox without developing or distributing an additional project in providing the new function.

In operation S320, the processor 220 may generate the new AI function by fusing the action provided from the toolbox with an LLM. Some example embodiments may support the role of an action selector that provides an intelligent function by fusing functions provided from the toolbox and the LLM. In some example embodiments, API specification and description may be specified in text for each function (e.g., action) generated through combination of steps in the toolbox, and a dynamic function may be provided through text by fusing specification for the action defined in text and the LLM.

The processor 220 may provide a dedicated toolbox and the action selector through an AI platform for generating an AI function.

While various AI functions are being developed, there are an increasing number of functions used by combining a plurality of AI models or used in combination with the LLM in addition to using a single function. Some example embodiments may introduce a dedicated toolbox that may execute a series of pipelines that develop a new AI function by quickly responding to various types of services within a platform in runtime. Also, according to some example embodiments, it is possible to provide the action selector in a structure that combines the AI function generated in the toolbox with the LLM, executes the AI function and returns results when a person (e.g., developer) makes a query in natural language. For example, when an action is generated in the toolbox, API specification may be specified in a text form, and the LLM may include the action selector structure that understands and executes a function related to the action based on the action specification specified in text.

The toolbox structure according to some example embodiments is described in detail as follows.

### (1) Step

The step may denote a single execution unit that is executed in the toolbox. The step may not be executed alone, and may be executed when an executable function unit, called an action, is generated. For example, the step may correspond to an actual code on a one-to-one basis, and an actual execution code may be versioned and managed according to a major version. Each step may correspond to an actual code on a one-to-one basis. Therefore, if a code is changed, the step is also changed.

In some example embodiments, components of the step may include a name, a version, an input schema, an output schema, and an option. A version of the step may be managed in (major. minor) format, and if minor is different, they are interchangeable, and if major is different, they are not interchangeable. The input schema and the output schema represent an input value and an output value of the step. The option of the step refers to a variable required to execute the step, and is set when generating the action or is delivered as a parameter when executing the action.

The toolbox according to some example embodiments may include a step builder. Here, the step builder may connect a dynamically defined step specification to an actual execution code of a corresponding step, and may generate a step instance. The step builder defined for each step may be executed when an action is generated, and may be used to verify a validity regarding whether data that may be required when building the step or alternatively desired for building the step is defined in action specification.

An example of the step may be as follows:
‘string_join’ step

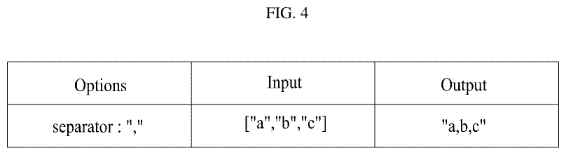

This step joins and returns an input string list. Join combines the string list into a single character string by inserting a specific or alternatively desired separator between the respective items. An example of join is illustrated in FIG. 4.

### (2) Action

The action, according to some example embodiments, represents a function unit that is provided in an executable API form from the toolbox. If a new action is defined and generated, the corresponding action generates a single API endpoint. For example, the action may represent a list of steps, such as, a pipeline.

The action may be defined by connecting the respective steps in a directed acyclic graph (DAG) form. Here, options of the action may include a name, input data, output data, description, and a step of the action. The description of the action according to some example embodiments refers to an explanation of a function of the action, and may be utilized in conjunction with an LLM through the action selector. For example, through the description of the action, the LLM may understand what function the action provides. The step of the action defines each step executed in the action, and may validate whether the input data required or alternatively advantageous for each step is input when generating the action.

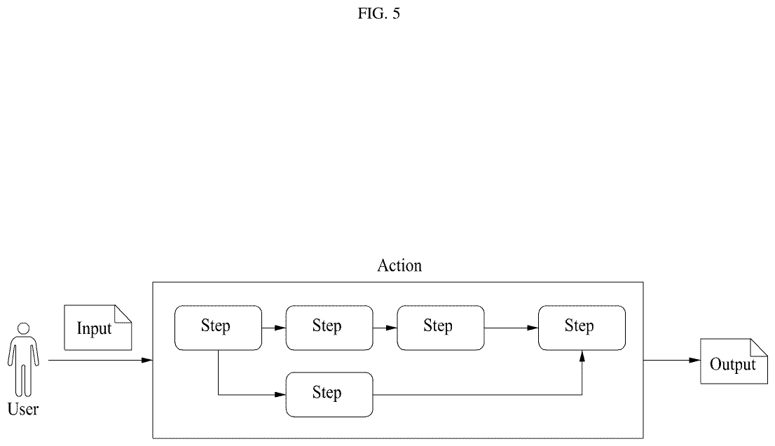

FIG. 5 illustrates an example of a structure of an action and a step of a toolbox according to some example embodiments.

The toolbox according to some example embodiments may include an action builder. For example, the action builder may serve to generate an executable action from action specification. The action builder may statically analyze whether a step specification set to each action is valid. Steps defined in the action execute a step builder to generate an executable step object. For example, the step builder verifies whether a value required for each step is sufficiently set, and dynamically analyzes whether output of a previous step and input of a subsequent step of the action are executable. The step builder may generate a step object, and the action builder may generate an action object having a step DAG. For example, a single action may be configured by performing a build task for each step and by collecting step build results, and may be generated in a memory.

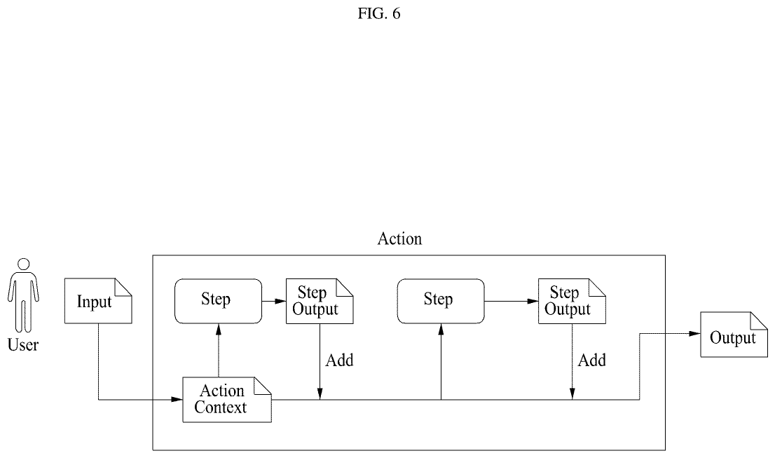

FIG. 6 illustrates an example of an action execution structure of a toolbox according to some example embodiments. If input is given by the user, an action may be executed in a structure in which action context to the input is generated and each step is executed according to the action to output final results.

An action selector that utilizes the toolbox in fusion with an LLM may be described in detail as follows.

The action selector may fuse and utilize the action specified in the toolbox with the LLM.

The toolbox according to some example embodiments serves to define specification for the action and to execute the corresponding action in a function unit in an API form, and the action selector serves to provide the action specified in text in the toolbox to the LLM and to execute the action selected by the LLM.

Each agent sets the action regarding what function is available, and the action selector provides input data, output data, and description specified in the action to the LLM through the agent, and supports a specific, or alternatively a desired function to be selected and executed.

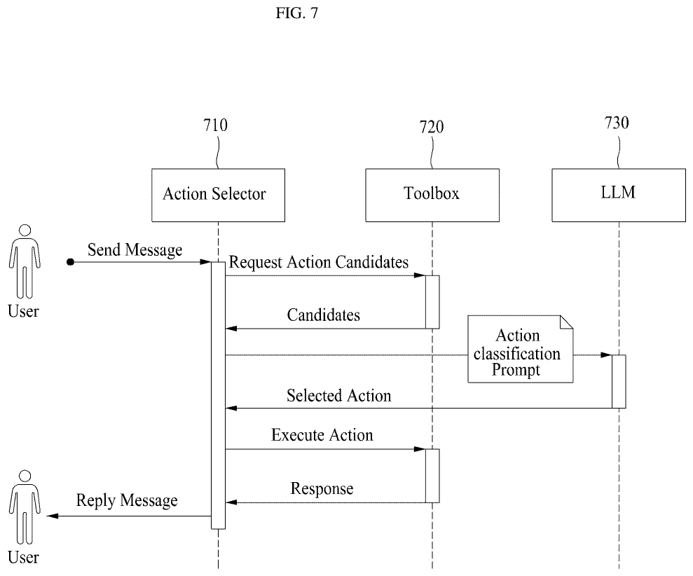

FIG. 7 illustrates an example of a flowchart of an action selector according to some example embodiments.

In some example embodiments it is possible to specify in advance what action each agent may perform and to manage each action through routing.

Referring to FIG. 7, an action selector 710 may ask an LLM 730 about what action to perform in response to a user query. For example, the action selector 710 may request action candidates corresponding to the user query (e.g., message) among actions provided from a toolbox 720. In some example embodiments, each of the action selector 710, toolbox 720, LLM 730 may include, may be included in, and/or may be implemented by one or more instances of processing circuitry such as hardware including logic circuits; a hardware/software combination such as a processor executing software; or a combination thereof. The action selector 710 may process the user query in a form that the LLM 730 may understand, and may send, to the LLM 730, a prompt (e.g., action classification prompt) that analyzes the intent of what action is suitable to provide in response to the user query. Accordingly, the LLM 730 may extract what action needs, or alternatively is suitable to be performed and what parameter is required or desirable, based on conversation content with the user. In some example embodiments, if parameters are extracted from the conversation content or if additional parameters are required or desirable, the parameters may be acquired by sending an additional query or message to the user.

The agent may maintain a list of actions to execute in response to the user query or message. In some example embodiments, if the user query is sent in a message form, the agent may deliver, to the toolbox 720, a candidate group for what actions of the agent to perform. For example, the agent may receive candidate group actions provided from the toolbox 720 through the action selector 710 and may ask the LLM 730 for what action among the candidate group actions is suitable for the user message. The action selector 710 may execute the action selected by the LLM 730 in the toolbox 720 and may finally deliver a corresponding response to the user.

A detailed process of building and distributing an action according to some example embodiments is as follows.

In general, when deploying a new action, a program may need to be modified or it may be advantageous to modify the program. For example, if one API is added, a new program is generated through a process of adding and building the API to the existing program. Therefore, a new function may be added by terminating and restarting a program of a server that is already running.

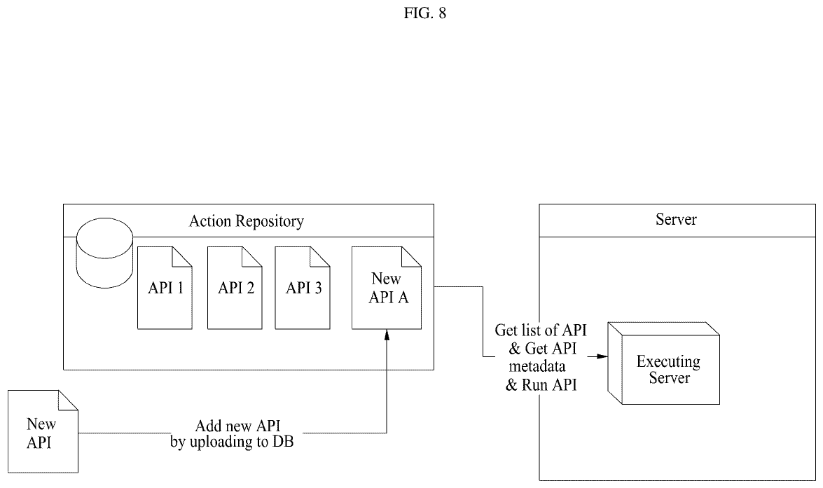

Some example embodiments follow a distribution method using the toolbox, which is as shown in FIG. 8. In some example embodiments, a new API and metadata use a form of text (e.g., JSON) that is easy to be stored in a database (DB). A server prepares information on an action to be retrieved from the database at any time. Without a need to restart the server, updated action information stored in the database may be retrieved and used. Therefore, in an example of adding the new API, it is sufficiently simply with storing the new API in the database. Compared to the existing method, it is easy to add/update/delete a new function without restarting a build of a server program or the server program. In an example of adding only a function and exporting the same to the outside, new action specification may be registered to the database without modifying the server.

An internal action load/build/execution process according to some example embodiments is as follows.

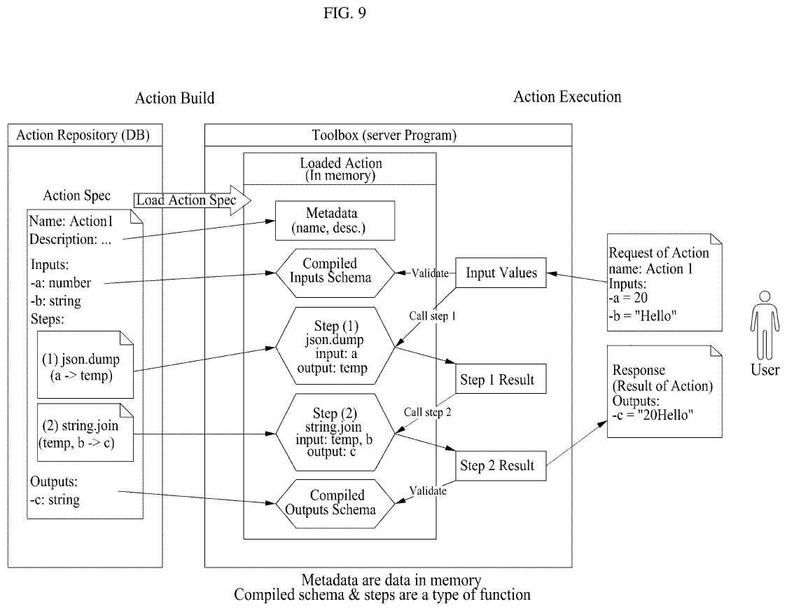

Referring to FIG. 9, in some example embodiments, in a situation in which the user requests the use of a specific, or alternatively a desired action, the server program (e.g., toolbox) may retrieve the action from a database. The server program (e.g., toolbox) may load action specification stored in an action repository (DB) and may store each item in a necessary, or alternatively a desired form. For example, metadata is stored as metadata, a value schema is used for validating input/output values, and stored as a function in advance to enable quick validation. Each step specification may be stored as a value calculated in advance from options and may correspond to an operation code of a step inherent in the toolbox.

In some example embodiments, if an action requested by the user is ready in a memory, a value may be input and sequentially executed. For example, an initial value is used as an input value and is validated with a previously prepared input schema. For example, a prepared compiled input schema function is used. Each step is executed in an execution order, and each step executes a step operation code (e.g., type of function) written in the toolbox. For example, output may be generated based on settings and input values calculated in advance from options loaded from step specification. A final output value may be validated with an output schema and then may be returned to the user.

A point of returning an action may be prepared immediately in response to a user request, and a frequently used action may be loaded from the database in advance. Each step is a type of function and may receive options that are included in specification and input values, and may output results. Examples calculated in advance from options may include generating a string array in advance to determine which input value to use as an option value, or generating in advance a client object for an external HTTP request.

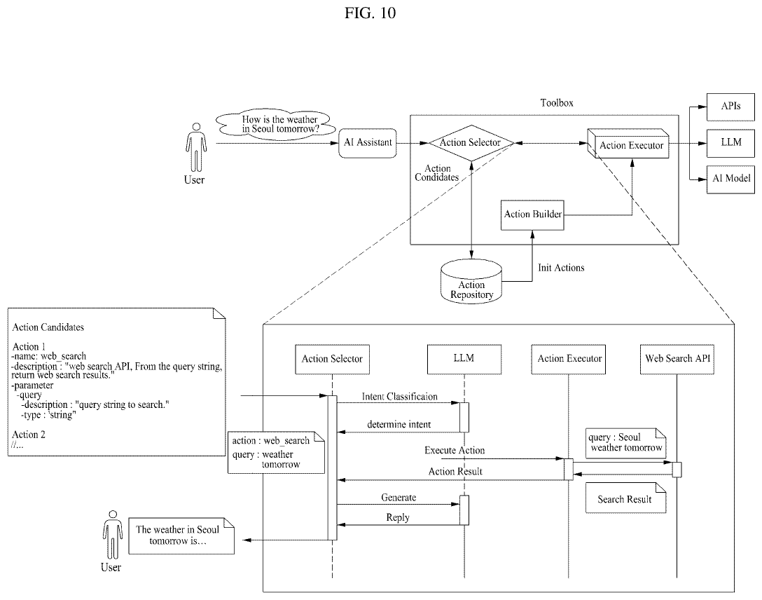

FIG. 10 illustrates a detailed execution example of an action that searches for weather according to some example embodiments. As an action suitable for the user's inquiry about weather, a reply to the user query (e.g., weather search results) may be returned by executing a web search action using an API, an LLM, and an AI model.

For example, an action of a toolbox may be specified in a form that allows input/output, description, and operation to be easily stored in a database and delivered to a network. The action may be stored in the database in a string format such as JSON, and the toolbox may load the action based on the stored specification and may receive input and perform validation and execution. Therefore, new action specification may be added, modified, or deleted without writing a separate program or restarting a server program. Specification and an action may correspond to each other through a name by simply adding action specification without a manual operation. For example, using the LLM, what action to perform may be determined from specification in a string form, and it is easy to deliver the specification to the LLM based on the action specification and to execute an action corresponding to a user request.

The apparatuses described above according to some example embodiments may be implemented using hardware components, software components, and/or combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In some example embodiments, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. For example, the media may continuously store computer-executable programs or may temporarily store the same for execution or download. In some example embodiments, the media may be various types of recording devices or storage devices in a form in which one or a plurality of hardware components are combined. Without being limited to media directly connected to a computer system, according to some example embodiments the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

While this disclosure includes some example embodiments, it will be apparent to one of ordinary skill in the art that various alterations and modifications in form and details may be made without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A computer device, comprising:
at least one processor configured to execute computer-readable instructions,
wherein the processor is configured to,
provide a toolbox for generating an artificial intelligence (AI) function as an application programming interface (API), and
execute the AI function through the toolbox and provide execution results in response to a request from a user.

2. The computer device of claim 1, wherein the toolbox includes a step that represents a single execution unit executed in the toolbox, and an action that represents a function unit provided in an API form executable in the toolbox.

3. The computer device of claim 2, wherein the step is managed in one-to-one correspondence with an actual execution code, and includes an input schema and an output schema, and a variable for execution.

4. The computer device of claim 2, wherein the action is defined by connecting at least two steps in a directed acyclic graph (DAG) form.

5. The computer device of claim 2, wherein the action is generated through a combination of steps, and an API specification and a description are specified in a text form.

6. The computer device of claim 2, wherein the toolbox includes a step builder configured to generate a step instance by connecting a specification of the step to an actual execution code of a corresponding step.

7. The computer device of claim 6, wherein the action is generated through a combination of steps, and
the step builder defined for each step is executed when the action is generated, and used to verify validity of data to build the step.

8. The computer device of claim 6, wherein the action is generated through a combination of steps, and
the step builder is configured to verify settings of a value for each step for the steps defined in the action, and verify output of a previous step and input of a subsequent action of the action.

9. The computer device of claim 6, wherein the toolbox includes an action builder configured to generate an executable action from an action specification, and
the action builder is configured to verify validity for step specification set to the action for the action that is generated through a combination of steps.

10. The computer device of claim 8, wherein the step builder is configured to generate step objects for the steps defined in the action, and
an action builder is configured to generate an action object with a step directed acyclic graph (DAG) according to the combination of the steps.

11. The computer device of claim 2, wherein the at least one processor is configured to provide an intelligent function by fusing the action provided from the toolbox with a large language model (LLM) as a role of an action selector.

12. The computer device of claim 11, wherein the action is generated through a combination of steps, and API specification and description are specified in a text form, and
the action selector is configured to provide a dynamic function through text by fusing specification for the action defined in text and the LLM.

13. The computer device of claim 11, wherein the action selector is configured to execute an action selected by the LLM in the toolbox in response to a query from the user, and deliver a reply to the query to the user.

14. The computer device of claim 11, wherein the action selector is configured to execute an action selected by the LLM in the toolbox as an action suitable for a query from the user among actions specified in text in the toolbox.

15. An artificial intelligence (AI) function providing method of a computer device comprising at least one processor, the AI function providing method comprising:
providing, by the at least one processor, a toolbox for generating an AI function as an application programming interface (API); and
executing, by the at least one processor, the AI function through the toolbox and providing execution results in response to a request from a user.

16. The AI function providing method of claim 15, wherein:
the toolbox includes a step that represents a single execution unit executed in the toolbox, and an action that represents a function unit provided in an API form executable in the toolbox,
the step is managed in one-to-one correspondence with an actual execution code, and
the action is defined by connecting at least two steps in a directed acyclic graph (DAG) form.

17. The AI function providing method of claim 16, wherein the providing of the execution results comprises providing an intelligent function by fusing the action provided from the toolbox with a large language model (LLM).

18. The AI function providing method of claim 16, wherein, in the action, API specification and description are specified in a text form in the toolbox, and
the providing of the execution results comprises providing a dynamic function through text by fusing specification for the action defined in text and a large language model (LLM).

19. The AI function providing method of claim 18, wherein the providing of the execution results comprises executing an action selected by the LLM in the toolbox as an action suitable for a query from the user among actions specified in text in the toolbox.

20. A non-transitory computer-readable recording medium storing instructions that, when executed by a processor, cause the processor to perform the AI function providing method of claim 15 on the computer device.
